(19) United States
(12) Patent Application Publication
(10) Pub. No.: US 2010/0073945 A1
(43) Pub. Date: Mar. 25, 2010

(54) Supporting stand with illuminating capability

(76) Inventor: Chen-Wei Chen, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,772

(22) Filed: Sep. 24, 2008

(51) Int. Cl. F21V 21/00

(52) U.S. Cl. 362/382

(57) ABSTRACT

A supporting stand with an illuminating capability includes: a base and a light-emitting device. The base has a first plate and a second plate extending from the first plate. An accommodating space is formed between the first plate and the second plate. The light-emitting device is provided at the front end of the second plate and separated from the first plate so as to generate a certain height. Via the above arrangement, a user puts a portable computer on the second plate of the base. The light-emitting device illuminates an external peripheral device connected to the portable computer. When the external peripheral device is not in use, it can be accommodated in the accommodating space without occupying space on a desk.

### BACKGROUND OF THE INVENTION

1. Field of the Invention

The present invention relates to a supporting stand, and in particular to a supporting stand with an illuminating capability on which a portable computer can be supported.

2. Description of Related Art

Since people use a computer more and more frequently and there is a need for a user to take his digital data to other places such as in giving a speech or travelling on official business, portable computers are thus developed. Since the advantageous characteristic of the portable computer is ease of transportation, the portable computer is designed based on light-and-compact construction.

Since a portable computer is small in thickness and volume, when a user puts the portable computer on a desk, the screen of the portable computer is usually located lower than the user's eyes. As a result, the user has to lower his head to observe the screen, which does not conform to ergonomics. After a long period of time, the user may feel uncomfortable and even injure his neck.

Therefore, manufacturer has developed a supporting stand for cooperating with the portable computer. The supporting stand is located below the portable computer, thereby raising the portable computer to a position at which the user feels comfortable when observing the screen of the portable computer.

When the user uses the portable computer, the user also uses transmission lines to connect other peripheral devices such as a keyboard, mouse, floppy disk driver, optical disk driver, or the like, thereby increasing the convenience in operating the portable computer. However, after the external peripheral devices are used, there is no place on the desk to accommodate the above peripheral devices, which makes the surface of the desk untidy. Furthermore, if the external peripheral devices are used while the illumination is insufficient, it is inconvenient for the user to use the external peripheral devices.

Consequently, because of the above limitation resulting from the technical design of prior art, the inventor strives via real world experience and academic research to develop the present invention, which can effectively improve the limitations described above.

### SUMMARY OF THE INVENTION

The object of the present invention is to provide a supporting stand with an illuminating capability for supporting a portable computer, in which a light-emitting device is provided at a base to illuminate external peripheral devices connected with the portable computer. Thus, it is convenient for the user to operate the peripheral devices.

Another object of the present invention is to provide a supporting stand with an illuminating capability for supporting a portable computer. The base is provided with an accommodating space for accommodating the external peripheral devices of the portable computer in the base, thereby reducing the occupied space.

In order to achieve the above objects, the present invention provides a supporting stand with an illuminating capability, which includes: a base comprising a first plate and a second plate extending from the first plate, an accommodating space being formed between the first plate and the second plate; and a light-emitting device provided at the front end of the second plate, the light-emitting device being separated from the first plate to generate a certain height.

The present invention further provides a supporting stand with an illuminating capability, which includes: a base comprising a first plate, a second plate, and a third plate, the second plate being formed by extending from the first plate, a first accommodating space being formed between the second plate and the first plate, the third plate being pivotally connected to the second plate, a second accommodating space being formed between the third plate and the second plate; and a light-emitting device provided at the front end of the second plate, the light-emitting device being separated from the first plate to generate a certain height.

The present invention has advantageous features as follows.

(I) The base is provided with an accommodating space for accommodating the external peripheral devices of the portable computer. Thus, the present invention occupies less space.

(II) When the user intends to use the external peripheral device of the portable computer, the user can take the peripheral device out of the accommodating space and dispose it in front of the base. Furthermore, with the illuminating effect generated by the light-emitting device, it is convenient for the user to operate the peripheral device.

In order to further understand the characteristics and technical contents of the present invention, a detailed description relating thereto will be made with reference to the accompanying drawings. However, the drawings are illustrative only, but not used to limit the scope of the present invention.

### BRIEF DESCRIPTION OF THE DRAWINGS

FIG. 1 is an exploded perspective view showing a supporting stand with an illuminating capability according to a first embodiment of the present invention;

FIG. 2 is an assembled perspective view showing the supporting stand with the illuminating capability according to the first embodiment of the present invention;

FIG. 3 is a side view showing the supporting stand with the illuminating capability according to the first embodiment of the present invention;

FIG. 4 is an exploded perspective view showing a supporting stand with an illuminating capability according to a second embodiment of the present invention;

FIG. 5 is an exploded perspective view along another angle showing the supporting stand with the illuminating capability according to the second embodiment of the present invention;

FIG. 6 is an assembled perspective view showing the supporting stand with the illuminating capability according to the second embodiment of the present invention;

FIG. 7 is a side view showing the supporting stand with the illuminating capability according to the second embodiment of the present invention; and

FIG. 8 is a schematic view showing an operating state of the supporting stand with the illuminating capability according to the second embodiment of the present invention.

### DETAILED DESCRIPTION OF PREFERRED EMBODIMENTS

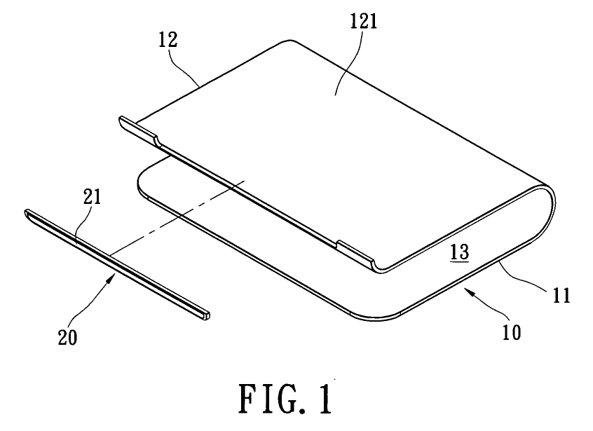

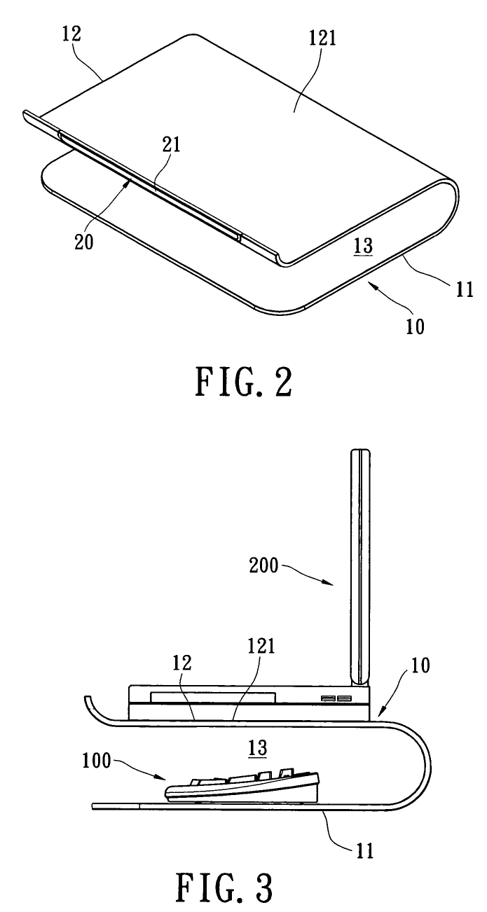

Please refer to FIGS. 1 to 3, which show a supporting stand with an illuminating capability according to a first embodiment of the present invention. The supporting stand includes a base 10 and a light-emitting device 20. The base 10 is not limited to be made of a specific material. In the present embodiment, the base 10 is made of metallic materials having heat conductivity. The base 10 comprises a first plate 11 and a second plate 12. The first plate 11 is a horizontal plate that can be disposed on a working plane such as a surface of a desk or table.

In the present embodiment, the second plate 12 is integrally formed with the first plate 11, but it is not limited thereto. The second plate 12 is formed by bending forwards from the rear end of the first plate 11 and extending in parallel thereto, so that the base 10 forms a U-shaped structure. The top of the second plate 12 is provided with a supporting surface 121 for allowing a portable computer 200 to be disposed thereon. Furthermore, an accommodating space 13 is formed between the second plate 12 and the first plate 11 for accommodating an article such as, but not limited to, an external peripheral device 100 (e.g. keyboard) connected to the portable computer 200.

The light-emitting device 20 is disposed at the front end of the second plate 12. Furthermore, the light-emitting device 20 is separated from the first plate 11 to generate a certain height. The interior of the light-emitting device 20 has a light-emitting source (not shown) such as any kind of light-emitting diode, lamp tube, or the like. The front end of the light-emitting device 20 is provided with a lamp cover 21 corresponding to the light-emitting source, thereby generating a uniform light-emitting effect. The lamp cover 21 can be shaped according to practical demands. In the present embodiment, the lamp cover 21 is elongated but is not limited thereto. With the above constitution, the supporting stand with an illuminating capability can be obtained.

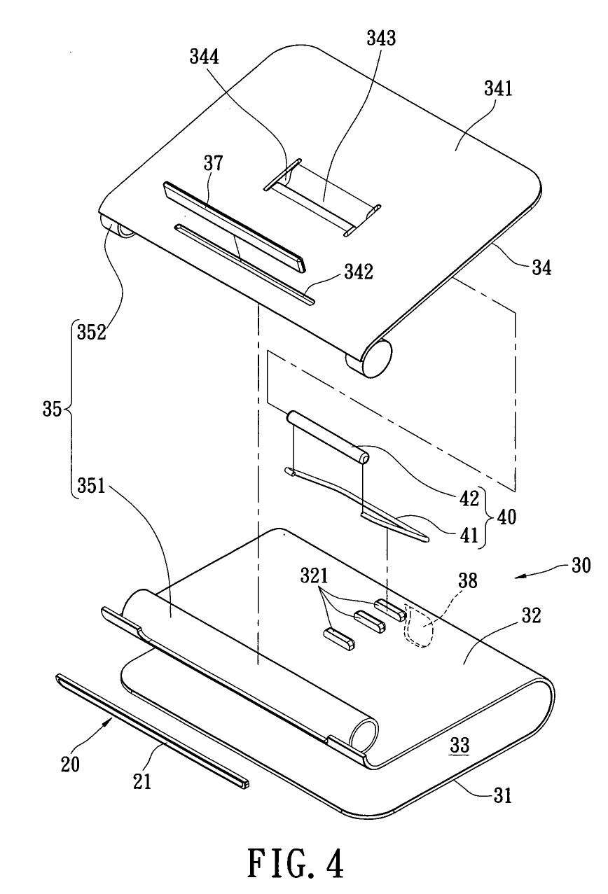

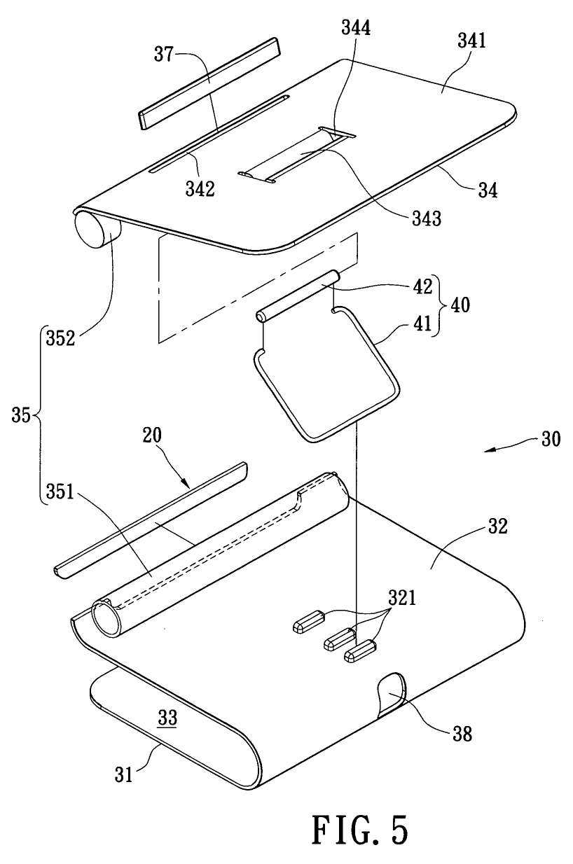

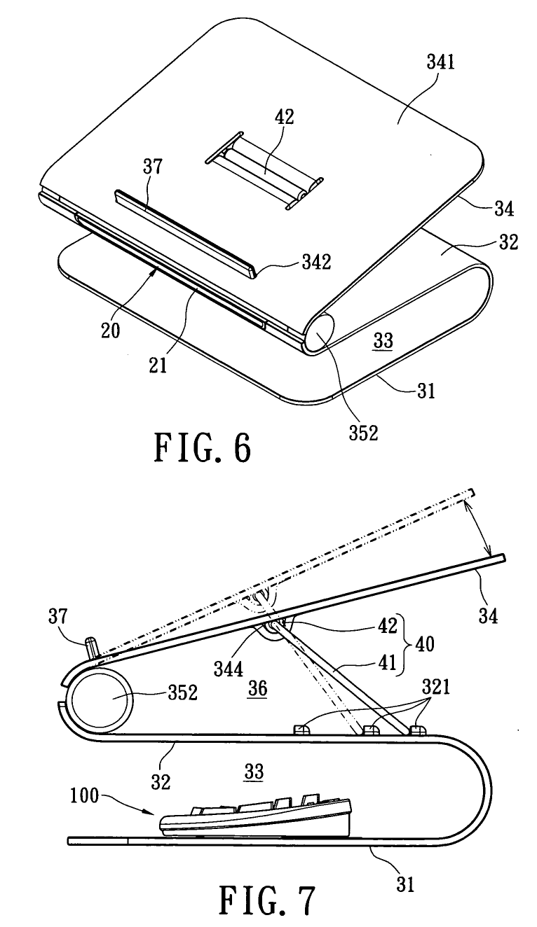

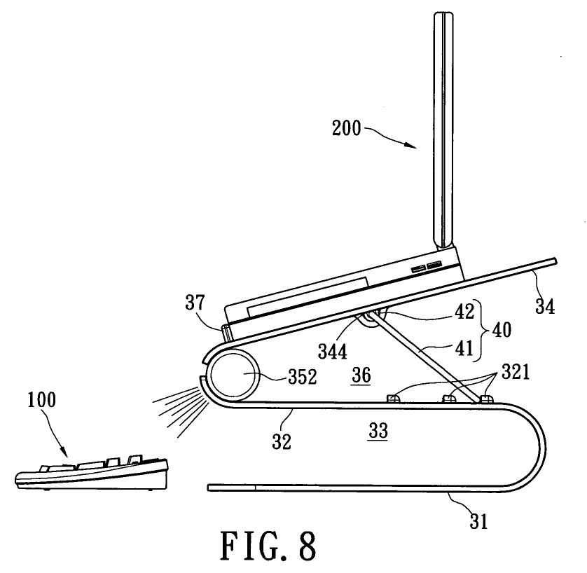

Please refer to FIGS. 4 to 6, which show a supporting stand with an illuminating capability according to a second embodiment of the present invention. The same elements of the second embodiment as those of the first embodiment are indicated by the same reference numerals. The supporting stand includes a base 30, a supporting means 40, and a light-emitting device 20. In the present embodiment, the base 30 is similarly made of metallic materials, which comprises a first plate 31, a second plate 32, a third plate 34, a pivoting means 35, and a retaining plate 37. The second plate 32 is integrally formed with the first plate 31, but it is not limited thereto. The second plate 32 is formed by bending forwards from the rear end of the first plate 31 and extending in parallel thereto. The top surface of the second plate 32 is provided with a plurality of retaining blocks 321 that are arranged at intervals. The top of the third plate 34 is provided with a supporting surface 341 for allowing the portable computer 200 (FIG. 8) to be disposed thereon. The third plate 34 is provided with a trough 342 adjacent to its front end. The retaining plate 37 is inserted into the trough 342, thereby preventing the portable computer 200 from falling off the third plate 34. The center of the third plate 34 is further provided with an accommodating trough 343. Both sides of the accommodating trough 343 are respectively formed with a through hole 344.

The pivoting means 35 is provided between the third plate 34 and the second plate 32, which comprises a first pivoting piece 351 and a second pivoting piece 352. The number of the first pivoting piece 351 and the second pivoting piece 352 is not limited to a specific number. In the present embodiment, one first pivoting piece 351 cooperates with two second pivoting pieces 352. The first pivoting piece 351 is provided on the second plate 32 adjacent to the center of its front end. The two second pivoting pieces 352 are provided on both sides of the third plate 34 respectively. Two of the second pivoting pieces 352 are respectively combined with two sides of the first pivoting piece 351 correspondingly, so that the third plate 34 can be pivotally connected to the second plate 32 via the pivoting means 35. In this way, the elevating angle of the third plate 34 with respect to the second plate 32 can be adjusted.

Since the first plate 31 and the second plate 32 together constitute a U-shaped structure, with the third plate 34 pivotally connected to the front end of the second plate 32, the base 30 is formed into a substantially S-shaped structure. As a result, a first accommodating space 33 is formed between the second plate 32 and the first plate 31, while a second accommodating space 36 is formed between the third plate 34 and the second plate 32 (please also refer to FIG. 7), thereby accommodating the external peripheral device 100. Furthermore, the rear end of the base 30 is provided with a penetrating hole 38 between the first plate 31 and the second plate 32. The penetrating hole 38 allows the transmission lines of the external peripheral devices 100 to be pass through, thereby the transmission lines may connect with the portable computer 200 in a more tidy and direct way.

The supporting means 40 is provided between the third plate 34 and the second plate 32. The supporting means 40 comprises a support 41 and a connecting piece 42. The support 41 is formed by means of bending a metallic rod. The connecting piece 42 is rotatably accommodated in the accommodating trough 343 of the third plate 34. One end of the support 41 passes through the through hole 344 of the third plate 34 and is fixed to the connecting piece 42, so that the end of the support 41 is connected to the third plate 34 via the connecting piece 42 and is rotatable with respect to the third plate 34. The other end of the support 41 adjustably abuts one of the retaining blocks 321 on the surface of the second plate 32, so that the third plate 34 is inclined. Therefore, with the other end of the support 41 abutting different retaining blocks 321, the inclination angle of the third plate 34 can be adjusted (FIG. 7).

The light-emitting device 20 is also provided with a lamp cover 21 that is disposed at a front end of the second plate 32. The light-emitting device 20 is separated from the first plate 31 to generate a specific height.

Therefore, please refer to FIG. 8. When the user intends to use the external peripheral device 100 (e.g. an external keyboard), the user can take the external keyboard out of the first accommodating space 33 and put it in front of the base 30, so that the light emitted by the light-emitting device 20 can illuminate the external keyboard.

According to the supporting stand with the illuminating capability of the present invention, it has advantageous features and functions as follows.

(I) The base is shaped to have an accommodating space for accommodating the external peripheral device (i.e. an external keyboard, FIG. 3). Thus, for example, if the user is not using the external keyboard, the user can accommodate the external keyboard in the accommodating space below the base without occupying space on the desk.

(II) When the user intends to use the external keyboard, the user can take the external keyboard out of the accommodating space and dispose it in front of the base (FIG. 8). The light emitted by the light-emitting device can illuminate the external keyboard, so that it is convenient for the user to operate the external keyboard. Even though the illumination in the surrounding environment is insufficient, the user can still see the positions of each key on the keyboard very clearly due to the light of the light-emitting device.

(III) According to the second embodiment of the present invention, since the base is provided with a first accommodating space and a second accommodating space at the same time, a plurality of external peripheral devices (such as transmission lines, a transformer, floppy disk driver, or optical disk driver) can be accommodated in the second accommodating space, which makes the surface of the desk tidy and clear.

(IV) Since the elevating angle of the third plate of the second embodiment can be freely adjusted via the pivoting means, so that the inclination of a portable computer disposed on the third plate can be changed based on the user's demand. Thus, the viewing angle of a screen of the portable computer can be also adjusted, which conforms to the ergonomics.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A supporting stand with an illuminating capability, comprising:
a base having a first plate and a second plate extending from the first plate, an accommodating space being formed between the first plate and the second plate; and
a light-emitting device provided at the front end of the second plate, the light-emitting device being separated from the first plate to generate a certain height.

2. The supporting stand with the illuminating capability according to claim 1, wherein the base is made of metallic materials.

3. The supporting stand with the illuminating capability according to claim 1, wherein the second plate is formed by bending forwards from the rear end of the first plate and extending in parallel thereto, thereby forming the base into a U-shaped structure.

4. The supporting stand with the illuminating capability according to claim 1, wherein the second plate is integrally formed with the first plate.

5. The supporting stand with the illuminating capability according to claim 1, wherein the top of the second plate is provided with a supporting surface.

6. The supporting stand with the illuminating capability according to claim 1, wherein the light-emitting device is provided with a lamp cover.

7. A supporting stand with an illuminating capability, comprising:
a base having a first plate, a second plate, and a third plate, the second plate being formed by extending from the first plate, a first accommodating space being formed between the second plate and the first plate, the third plate being pivotally connected to the second plate, a second accommodating space being formed between the third plate and the second plate; and
a light-emitting device provided at the front end of the second plate, the light-emitting device being separated from the first plate to generate a certain height.

8. The supporting stand with the illuminating capability according to claim 7, wherein the base is made of metallic materials.

9. The supporting stand with the illuminating capability according to claim 7, wherein the base is provided with a penetrating hole between the first plate and the second plate.

10. The supporting stand with the illuminating capability according to claim 7, wherein the second plate is formed by bending forwards from the rear end of the first plate and extending in parallel thereto.

11. The supporting stand with the illuminating capability according to claim 7, wherein the second plate is integrally formed with the first plate.

12. The supporting stand with the illuminating capability according to claim 7, wherein the top of the third plate is provided with a supporting surface.

13. The supporting stand with the illuminating capability according to claim 7, wherein the base further comprises a retaining plate provided adjacent to the front end of the third plate.

14. The supporting stand with the illuminating capability according to claim 13, wherein the third plate is provided with a trough, and the retaining plate is inserted into the trough.

15. The supporting stand with the illuminating capability according to claim 7, wherein the light-emitting device is provided with a lamp cover.

16. The supporting stand with the illuminating capability according to claim 7, further comprising a pivoting means provided between the third plate and the second plate, the pivoting means comprising at least one first pivoting piece connected to the second plate and at least one second pivoting piece connected to the third plate, the second pivoting piece being connected to the first pivoting piece thereby adjusting the elevating angle of the third plate with respect to the second plate.

17. The supporting stand with the illuminating capability according to claim 16, further comprising a supporting means, the supporting means being provided between the third plate and the second plate, the top surface of the second plate being provided with a plurality of retaining blocks arranged at intervals, the third plate being provided with an accommodating trough, the supporting means comprising a support and a connecting piece, the connecting piece being rotatably accommodated in the accommodating trough, one end of the support being connected to the connecting piece and the other thereof adjustably abutting the retaining blocks to thereby make the third plate inclined.

18. The supporting stand with the illuminating capability according to claim 7, further comprising a supporting means, the supporting means being provided between the third plate and the second plate, the top surface of the second plate being provided with a plurality of retaining blocks arranged at intervals, the third plate being provided with an accommodating trough, the supporting means comprising a support and a connecting piece, the connecting piece being rotatably accommodated in the accommodating trough, one end of the support being connected to the connecting piece and the other thereof adjustably abutting the retaining blocks to thereby make the third plate inclined.
